(19) United States
(12) Patent Application Publication
(10) Pub. No.: US 2026/0338294 A1
(43) Pub. Date: Oct. 29, 2026

(54) FLOATING BALL VALVE

(71) Applicant: Valve Innovations, LLC, Oklahoma City, OK (US)

(72) Inventors: John P. Scaramucci, Oklahoma City, OK (US); Danny R. Lowe, Oklahoma City, OK (US); Stephen M. Rhodes, Oklahoma City, OK (US)

(21) Appl. No.: 19/190,157

(22) Filed: Apr. 25, 2025

(51) Int. Cl. F16K 5/06; F16K 27/06; F16K 31/60; F16K 35/00; F16K 41/16

(52) U.S. Cl. CPC F16K 5/0647; F16K 31/602; F16K 35/00; F16K 41/16; F16K 27/067

(57) ABSTRACT

A valve including a body assembly, a valve member positioned in the body assembly and movable between an open position and a closed position, a stem journaled in an aperture of the body assembly and engaging the valve member, a stop pin projecting from the body assembly and spaced from the stem, and a stop plate positioned on an outer end of the stem so a portion of the outer end of the stem extends beyond the stop plate. The stop plate has a first shoulder and a second shoulder. The first shoulder is positioned to engage a first portion of the stop pin when the valve member is in the open position, and the second shoulder is positioned to engage a second portion of the stop pin when the valve member is in the closed position. The stop plate is bonded to the stem.

### BACKGROUND

Valves are critical components in the infrastructure of the petroleum and natural gas industry. The integrity and proper operation of these valves are paramount to ensuring safety and preventing environmental hazards. Improper valve operation, including unauthorized manipulation or leakage, can lead to significant risks, including property damage, environmental contamination, and potential loss of life.

Conventional methods for securing valve handles, such as padlocks, have been employed to prevent unauthorized operation. However, these methods introduce substantial cost burdens, particularly in high-volume applications with tens of millions of valves deployed. Moreover, the cost of padlocks, especially those suitable for harsh environments, can exceed the price of the valves themselves, rendering this solution economically inefficient.

Furthermore, externally mounted valve handles, readily accessible on equipment or manifolds, are susceptible to tampering and vandalism. To mitigate this issue, operators often remove the handle and locking mechanism, rendering the valve less inviting to unauthorized manipulation. However, this practice can compromise valve functionality and introduce other operational challenges.

Existing ball valve designs typically integrate rotational stops and stem seal preload mechanisms within the handle and locking assembly. This integration presents several drawbacks.

Rotational stops define the angular position of the ball valve's internal orifice, dictating the valve's open or closed state. Precise control of this rotation is essential for achieving optimal sealing. Even minor deviations in rotational positioning can result in leakage or seepage, particularly at low pressures. Accurate and reliable rotational stops ensure proper valve operation and prevent fugitive emissions.

Stem seals are critical for preventing fluid leakage along the stem. Conventional stem seal designs employ two primary methods: adjustable packing and pressure-actuated seals (e.g., O-rings). Adjustable packing seals, which rely on radial compression, are prone to leakage due to inadequate maintenance and stem deflection under handle load. While effective at high pressures, pressure-actuated seals often exhibit seepage at low pressures due to imperfections in the sealing surface or stem misalignment, leading to fugitive emissions.

In many conventional designs, the handle-to-stem connection, typically a nut or screw, also provides preload to the stem seal. Removal of the handle and locking mechanism can eliminate this preload, thereby compromising the low-pressure sealing capability of the valve.

The existing art suffers from several limitations, including the high cost associated with external locking mechanisms, the susceptibility to tampering and vandalism, the integration of critical valve functions (rotational stops and stem seal preload) within the removable handle assembly, the inadequate sealing performance, particularly at low pressures, and the maintenance challenges associated with adjustable packing seals. Therefore, an improved ball valve design is needed to address these limitations, providing a cost-effective, secure, and reliable solution for petroleum and natural gas applications.

### SUMMARY OF THE INVENTIVE CONCEPTS

The present invention provides an improved ball valve design that addresses the limitations of conventional valves, particularly those employed in petroleum and natural gas applications. In one aspect, the inventive concepts disclosed herein feature a stem and seal assembly that is preloaded through compression during a bonding process. This compression-induced preload, particularly critical for upper and lower stem seals, ensures effective sealing at low pressures and significantly reduces the risk of fugitive emissions.

In another aspect, the inventive concepts disclosed include a stop plate welded directly to the stem. This welded connection enables the complete removal of the valve handle and locking device without compromising the functionality of the rotational stops. This design also significantly enhances tamper resistance, preventing unauthorized manipulation of the valve.

In summary, the inventive concepts disclosed herein provide a ball valve design that allows for the complete removal of the handle and locking mechanism while maintaining the critical rotational stop functionality. Additionally, the bonded stem and seal assembly permanently seals the stem, preventing external contamination, providing enhanced internal sealing, and further enhancing the reliability and longevity of the valve.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of a floating ball valve constructed in accordance with the inventive concepts disclosed herein.

FIG. 2 is an exploded, perspective view of the floating ball valve of FIG. 1.

FIG. 3 is a sectional view of the floating ball valve taken along line 3-3 of FIG. 1.

FIG. 4 is a sectional view illustrating of a stem 16 positioned in a valve body with a stop plate bonded to the stem 16.

FIG. 5 is a perspective of the stop plate.

FIG. 6 is a top plan view of the floating ball valve with the handle and locking plate removed.

FIG. 7 is a perspective view of the floating ball valve of FIG. 6.

FIG. 8 is a perspective view of a handle.

FIG. 9 is an exploded perspective view of a locking plate and a spacer.

### DETAILED DESCRIPTION OF EXEMPLARY EMBODIMENTS

Before explaining at least one embodiment of the inventive concepts in detail, it is to be understood that the inventive concepts disclosed herein are not limited in its application to the details of construction, experiments, exemplary data, and the arrangement of the components set forth in the following description or illustrated in the drawings. The inventive concepts are capable of other embodiments or being practiced or carried out in various ways. Also, it is to be understood that the phraseology and terminology employed herein is for purposes of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including but not limited to each of, 2, 3, 4, 5, 10, 15, 20, 30, 40, 50, 100, and all integers and fractions, if applicable, therebetween. The terms “at least one” and “one or more” may extend up to 100 or 1000or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

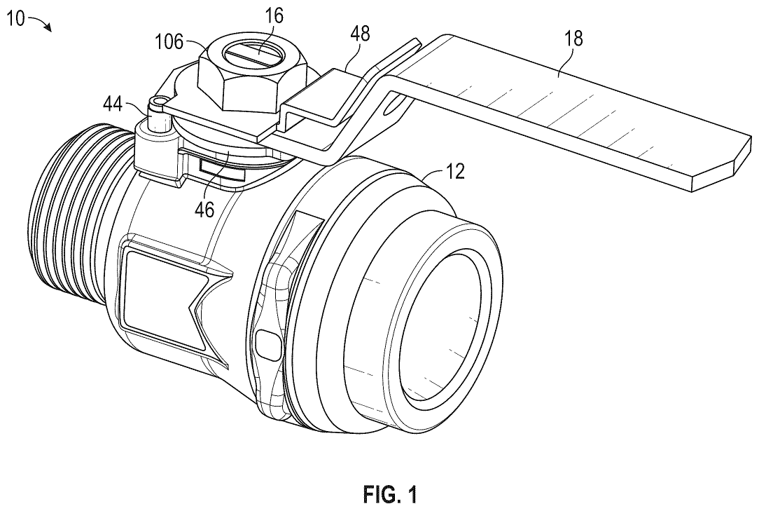

Referring now to the drawings, and more particularly to FIG. 1, a floating ball valve 10 constructed in accordance with the inventive concepts disclosed herein is illustrated. The floating ball valve 10 includes a body assembly 12, a valve member 14 disposed in the body assembly 12 for rotation between an open position (FIG. 1) and a closed position (not shown), and a stem 16 to which a handle 18 is connected for rotating the valve member 14 between the open position and the closed position. The floating ball valve 10 further includes a pair of seats 19 and 20 for forming a seal between the body assembly 12 and the valve member 14, a stop pin 44, a stop plate 46, and a lock plate 48.

The body assembly 12, as shown in FIGS. 1-3, includes a body 22, a first end adaptor 24 illustrated as being integrally formed with a body 22 as one piece, and a second end adapter 26 connected to the opposing end of the body 22. It will be appreciated by those of ordinary skill in the art that the body assembly 12 may be fabricated in three portions, where each of the end adaptors 24 and 26 is connected to the body 22. Further, the end adapters 24 and 26 may be provided in a variety of forms, such as flanged (e.g., end adapters 24 and 26), welded, and threaded.

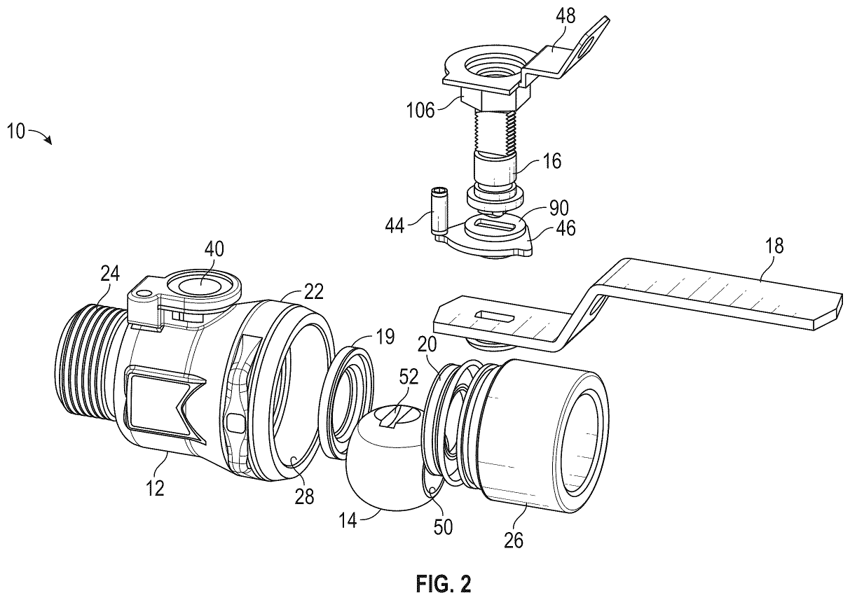

The body assembly 12 has a centrally disposed valve chamber 28, and an inlet passage 30 and an outlet passage 32 in communication with the valve chamber 28 to form a flow passageway through the body assembly 12. A first seat pocket 36 is formed about the inlet passage 30, and a second seat pocket 38 is formed about the outlet passage 32. The first seat pocket 36 is adapted to receive the seat 19, and the second seat pocket 38 is adapted to receive the seat 20. An aperture 40 (FIG. 2) extends perpendicular through the body assembly 12 for receiving the stem 16.

Referring now to FIGS. 1-5, the valve member 14 has a generally spherical shape and is mounted within the valve chamber 28 for rotation about an axis between the open position and the closed position, wherein the valve member 14 is rotated substantially 90 degrees from the open position to the closed position. The valve member 14 has a central bore 50 which aligns with the inlet passage 30 and the outlet passage 32 in the open position of the valve member 14 to permit fluid passage through the valve 10 when the valve member 14 is in the open position. In the closed position of the valve member 14, the seat assemblies 18 and 20 engage the exterior surface of the valve member 14 and internal surfaces of the body assembly 12 to form fluid-tight seals that disrupt fluid communication between the inlet passage 30 and the outlet passage 32. The valve member 14 has an exterior slot 52 (FIG. 2) for receiving a key 42 (FIG. 4) at the distal end of the stem 16. The exterior slot 52 is sized with respect to the stem 16 to permit movement of the valve member 14 in an axial direction when the valve member 14 is rotated to the closed position. Thus, the valve member 14 is of the type known in the art as a “floating” valve member or valve ball.

A first seal 56 fits in a groove (FIG. 4) around the central portion of the stem 16 to prevent leakage from the valve chamber 28 through the aperture 40 around the stem 16. The first seal 56 may be in the form of an O-ring. The stem 16 is internally mounted and is provided with a flange 58 on the lower end portion thereof immediately above the key 42, which fits in a mating groove of the body assembly 12 to prevent the stem 16 from being removed from the body assembly 12 through the aperture 40. A second seal 62 may be positioned between the flange 58 and the body assembly 12. The second seal 62 may be a Teflon seal to create a seal and facilitate rotation of the stem 16.

A third seal 64 and a fourth seal 66 may be provided about the upper end of the stem 16 between the body assembly 12 and the stop plate 46. The third seal 64 may be an O-ring, and the fourth seal 66 may be a Teflon seal to create a seal and facilitate rotation of the stem 16. The third seal 64 and the fourth seal 66 prevent environmental intrusion to protect against corrosion and other operational issues.

The stop pin 44 is secured to the body assembly 12 so that the stop pin 44 projects from the body assembly 12 in a spaced-apart, parallel relationship to the stem 16.

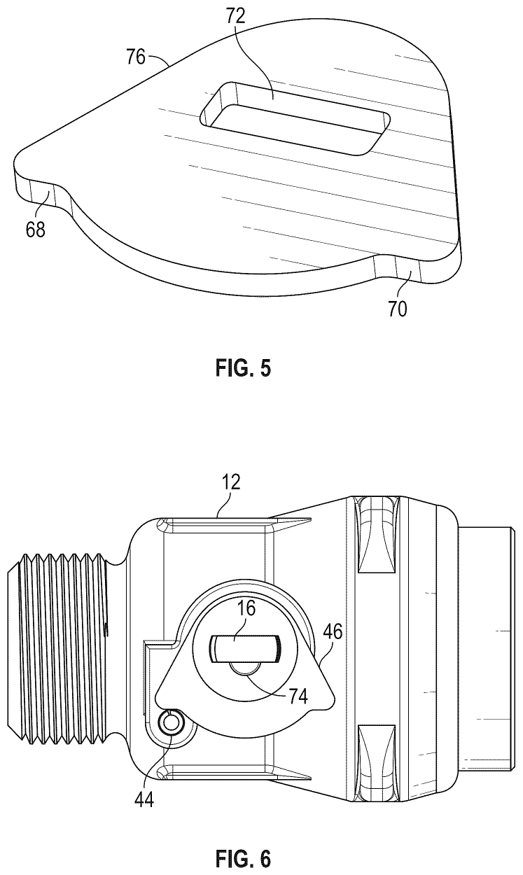

The stop plate 46 (best shown in FIG. 5) is positioned on the outer end of the stem 16 and has an aperture 72 through the central portion thereof to matingly receive the stem 16. The stop plate 46 can vary in shape and has a first shoulder 68 and a second shoulder 70. The first shoulder 68 is positioned to engage a first portion of the stop pin 44 when the valve member 14 is in the open position to prevent rotation of the valve member 14 beyond the open position. The second shoulder 70 is positioned to engage a second portion of the stop pin 44 when the valve member 14 is in the closed position to prevent rotation of the valve member 14 beyond the closed position. The shoulders 68 and 70 are positioned to limit the turning movement of the stem 16 to 90 degrees.

To enable the valve 10 to be operated with the handle 18 removed from the stem 16, the stop plate 46 is bonded or otherwise fixed to the stem 16. During the bonding process, a controlled compressive force is applied to the second and fourth seal members 62 and 66 along the longitudinal axis of the stem 16 by applying opposing forces to the stem 16 and the stop plate 46. This compressive force achieves a preload on the seal members 62 and 66. The compressive force can be applied in a variety of ways. In one embodiment, an upward axial force (represented by arrow 74 in FIG. 4) can be applied to the lower end of the stem 16 within the valve chamber 28, and a downward axial force (represented by arrows 76) can be applied to the stop plate 46. The forces may be applied using a compression jig or machine (not shown), wherein the jig or machine is configured to apply and maintain the compressive force during a subsequent bonding process. The jig or machine may incorporate calibrated springs or hydraulic actuators to achieve the desired predetermined preload.

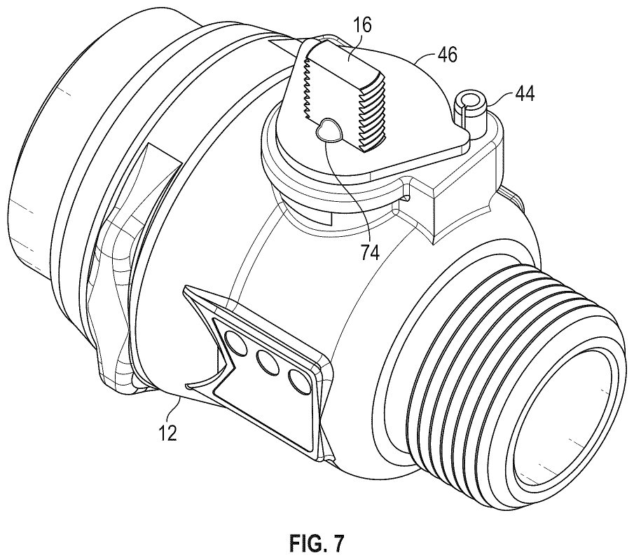

While maintaining the compressive force on the seal members 62 and 66, the stop plate 46 is bonded to the stem 16. The bonding process may be performed using a suitable welding technique, such as Tungsten Inert Gas (TIG) welding or laser welding, to create a permanent connection between the stop plate 46 and the stem 16. A weld 78 is illustrated in FIGS. 6 and 7. The welding process is controlled to ensure that the predetermined preload on the seal members 62 and 66 is maintained throughout the bonding operation, preventing relaxation of the compressive force.

Following the completion of the welding process, and after the stop plate 46 has been securely bonded to the stem 16, the compressive force applied by the compression jig is released. The resilient nature of the seal members 62 and 66 ensures that the predetermined preload is maintained even after the removal of the compressive force. The step plate 46 mechanically retains the preloaded force.

The resulting assembly comprises a stem 16, the seal members 62 and 66 under a predetermined compressive preload, and the stop plate 46 bonded to the stem 16. The preloaded seal members 62 and 66 ensure effective sealing with the handle 18 removed from the stem 16.

While the stop plate 46 and the stem 16 are described as being bonded through TIG welding, various other welding techniques, such as MIG and arc welding, may be utilized depending on the specific material properties and application requirements. Alternatively, other bonding methods may be employed, including brazing or soldering, which utilize a filler metal with a lower melting point to join the metal pieces without melting the base materials. A press-fit connection may be utilized, wherein one metal piece is forcibly inserted into another with an interference fit to create a secure mechanical bond. Additionally, adhesive bonding with glues or epoxy resins may provide a viable solution in certain cases.

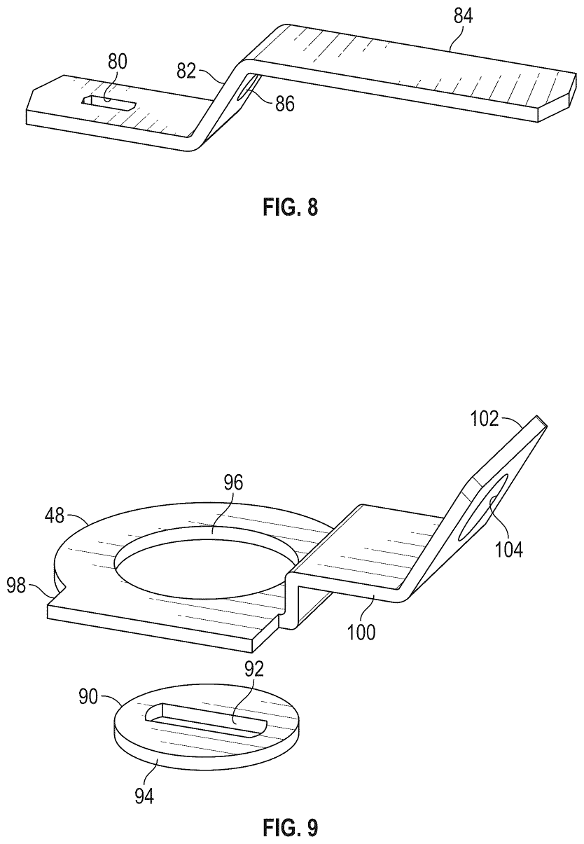

For conventional operation of the floating ball valve 10, the handle 18 is secured to the stem 16. The handle 18 has an opening 80 therethrough sized to mate with the stem 16, such that the stem 16 and the stop plate 46 will be turned upon turning the handle 18 to open and close the valve member 14. As shown in FIG. 8, the handle 18 extends for a distance perpendicularly to the stem 16 and then is bent to form a portion 82 extending outwardly from the valve 32 at an angle, and is then again bent to provide an outer end portion 84 again extending at right angles to the axis of the stem 16. The angled portion 82 of the handle 18 has an aperture opening 86 therethrough which forms a lock aperture, as will be set forth more fully below.

A spacer 90 is positioned on the outer end of the stem 16. The spacer 90 (FIG. 9) has an opening 92 therethrough sized to mate with the stem 16, such that the stem 16, the stop plate 46, and the spacer 90 will be turned upon turning the handle 18 to open and close the valve member 14. The spacer 90 has a circular outer edge 94.

The lock plate 48 is positioned about the circular outer edge 94 of the spacer 90 on the outer end of the stem 16. The lock plate 48 has an opening 96 therethrough sized to mate with the circular outer edge 94 of the spacer 90. The spacer 90 has a shoulder 98 positioned to engage the second side of the stop pin 44 when the valve member 14 is in the open position to prevent rotation of the lock plate 48. As such, the stem 16, the stop plate 46, and the spacer 90 will be turned upon turning the handle 18 to open and close the valve member 14, but the lock plate 48 will remain stationary.

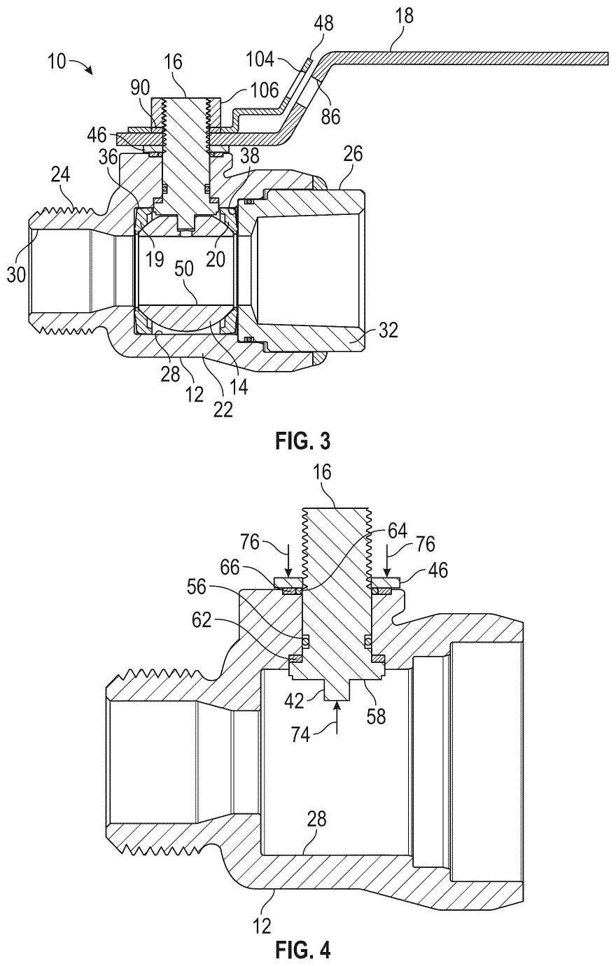

The lock plate 48 has a handle portion 100 extending generally away from the stem 16 and an angled portion 102. The angled portion 102 is constructed to be parallel with the angled portion 82 of the handle 18 when handle 18 is in the open position as shown in FIG. 3. The angled portion 102 of the lock plate 48 has an opening 104 therethrough sized and positioned to align with the opening 86 of the handle 18 when the valve member 14 is in the open position. Thus, when a shank of a lock (not shown) is inserted through the mating openings 86 and 104 of the handle 18 and lock plate 48, respectively, the valve member 14 will be locked in the open position. It will be appreciated that the lock plate 48 may be configured to permit the valve member 14 to be locked in the closed position, if desired.

A stem nut 106 secures the handle 18 and the lock plate 48 on the stem 16. It will be appreciated from the above that stem nut 106 typically provides preload to the stem seals. In prior art valves, removal of the handle 18 and the lock plate 48 can eliminate this preload, thereby compromising the sealing capability of the valve.

The floating ball valve 10 is designed for operation even with the handle 18 removed through the stop plate 46 being directly bonded to the stem 16. To operate the valve 10 without the handle 10, one would need to directly manipulate the stem 16 using a tool, such as a wrench. Despite the absence of the stem nut 106 and the handle 18, the stop plate 46 maintains the defined rotational stops, preserving the ability of the valve 10 to reach its open, closed, or other designated positions. Crucially, the preloaded seal members 62 and 66 ensure the sealing integrity of the valve 10 even when operated in this manner, preventing leaks and fugitive emissions. This design prioritizes tamper resistance, making it suitable for applications where unauthorized valve manipulation poses a significant risk.

From the above description, it is clear that the present invention is well adapted to carry out the objects and to attain the advantages mentioned herein as well as those inherent in the invention. While exemplary embodiments of the invention have been described for purposes of this disclosure, it will be understood that numerous changes may be made which will readily suggest themselves to those skilled in the art and which are accomplished within the spirit of the invention disclosed and as defined in the appended claims.

1-7. (canceled)

8. A method of assembling a valve, comprising:
providing a valve body having a valve chamber and an inlet passage and an outlet passage in communication with the valve chamber;
mounting internally a stem through a stem bore formed through the valve body so that the stem has an inner end positioned in the valve chamber and an outer end extending from the valve body, wherein a first seal member is positioned between the valve body and the stem;
positioning a valve member in the valve chamber and engaging the valve member with the stem so the valve member is movable between an open position and a closed position, the valve member having a flow passage formed therethrough for providing fluid communication between the inlet passage and the outlet passage of the valve body when the valve member is in the open position;
extending a stop pin from the valve body spaced from the stem;
positioning a stop plate on the outer end of the stem, the stop plate having a first shoulder and a second shoulder, the first shoulder positioned to engage a first portion of the stop pin when the valve member is in the open position to prevent movement of the valve member beyond the open position, and the second shoulder positioned to engage a second portion of the stop pin when the valve member is in the closed position to prevent movement of the valve member beyond the closed position, wherein a second seal is positioned between the stop plate and the valve body;
applying a preload to the first seal and the second seal by applying an upward axial force to the stem and a downward axial force to the stop plate; and
bonding the stop plate to the stem while applying the preload.

9-10. (canceled)

11. The method of claim 8, wherein the step of bonding the stop plate to the stem comprises welding the stop plate to the stem.

12. The method of claim 8, further comprising:
positioning a handle on the outer end of the stem for rotation thereof, the handle having at least one lock opening therethrough;
positioning a lock plate on the outer end of the stem and having a shoulder positioned to engage the second side of the stop pin when the valve member is in the open position to prevent movement of the lock plate, the lock plate having at least one lock opening therethrough positioned to mate with the lock opening of the handle when the valve member is in the open position; and
securing the handle and the lock plate on the stem.

13. The method of claim 12, further comprising removing the handle and the lock plate from the stem.
